(19) United States
(12) Patent Application Publication
(10) Pub. No.: US 2026/0284573 A1
(43) Pub. Date: Sep. 24, 2026

(54) CARBON DIOXIDE RECOVERY APPARATUS

(71) Applicant: HONDA MOTOR CO., LTD., Tokyo (JP)

(72) Inventors: Yu Arakawa, Wako-shi (JP); Masanobu Takazawa, Wako-shi (JP); Wataru Noguchi, Wako-shi (JP); Yuta Suzuki, Tokyo (JP); Toshio Kubota, Tokyo (JP)

(21) Appl. No.: 19/550,107

(22) Filed: Feb. 25, 2026

(30) Foreign Application Priority Data
Mar. 19, 2025 (JP) 2025-045339

(51) Int. Cl. B01D 53/04; B01D 53/30

(52) U.S. Cl. CPC B01D 53/0454; B01D 53/0446; B01D 53/30; B01D 2257/504; B01D 2259/40009

(57) ABSTRACT

A carbon dioxide recovery apparatus includes a reactor, a first oxygen sensor, a second oxygen sensor, a third oxygen sensor, and a control device. The reactor adsorbs and desorbs carbon dioxide in a process target gas by an adsorbent. The first oxygen sensor and the second oxygen sensor are arranged on an upstream side and a downstream side of a recovery pump in a recovery flow path, respectively. The third oxygen sensor is arranged on the reactor. The control device detects at least one of a carbon dioxide concentration of a recovery gas, a state of the reactor, and a state of the recovery flow path based on information of oxygen concentrations output from the first oxygen sensor, the second oxygen sensor, and the third oxygen sensor.

### CROSS-REFERENCE TO RELATED APPLICATION

Priority is claimed on Japanese Patent Application No. 2025-045339, filed on Mar. 19, 2025, the contents of which are incorporated herein by reference.

### BACKGROUND

### Field of the Invention

The present invention relates to a carbon dioxide recovery apparatus.

### Background

Efforts aimed at mitigating or reducing the impact of climate change have been ongoing, and research and development relating to reduction in carbon dioxide emission has been conducted to achieve this.

In the related art, for example, an apparatus is known which supplies a process target gas such as air to a module including an adsorbent of carbon dioxide and a pressure measurement portion and removes the carbon dioxide by adsorption and desorption (emission) of the carbon dioxide by the module (for example, Japanese Unexamined Patent Application, First Publication No. 2024-048937). The apparatus determines the presence or absence of desorption of the carbon dioxide from the adsorbent and the presence or absence of occurrence of an abnormality on the basis of a pressure at the inside of the module measured by the pressure measurement portion.

In the related art, for example, a carbon dioxide separation apparatus is known in which, in an adsorbent device that includes an adsorbent of carbon dioxide and a detector of a physical quantity such as temperature, an adsorption state such as breakthrough or saturation of the adsorbent is detected based on a change in the physical quantity detected by the detector (for example, refer to Japanese Unexamined Patent Application, First Publication No. 2022-126999).

### SUMMARY

In the reduction in carbon dioxide emission, it is a problem to be solved to accurately detect the details of the presence or absence of deterioration and abnormality of a recovery apparatus of carbon dioxide while preventing the cost required for the configuration of the recovery device from being increased. For example, in the apparatus as in the related art described above, when a detector appropriately selected from various detectors is used for performing a desired state determination, there is a possibility that the cost required for the apparatus configuration increases, and there is a possibility that it becomes difficult to improve the determination accuracy.

The present application aims at achieving prevention of an increase in cost required for an apparatus configuration and improvement of the accuracy of a desired state determination. Further, the present application contributes to mitigating or reducing the impact of climate change.

A carbon dioxide recovery apparatus according to a first aspect of the present invention includes: a reactor that has an adsorbent adsorbing carbon dioxide, and adsorbs and desorbs carbon dioxide in a process target gas by the adsorbent; a recovery flow path that is connected to the reactor and causes a recovery gas recovered from the reactor to flow through the recovery flow path; an oxygen detector that is arranged on at least one of the reactor and the recovery flow path and detects the oxygen concentration of the recovery gas; and a process device that detects at least one of a carbon dioxide concentration of the recovery gas, a state of the reactor, and a state of the recovery flow path based on information of the oxygen concentration output from the oxygen detector.

A second aspect is the carbon dioxide recovery apparatus according to the first aspect described above which may include: an open-close valve that is provided on the recovery flow path; a pump that is provided on a downstream side of the open-close valve in the recovery flow path and suctions the recovery gas from the reactor; and a plurality of the oxygen detectors each of which is the oxygen detector, wherein the plurality of the oxygen detectors may be provided on the reactor, in the recovery flow path between the open-close valve and the pump, and in the recovery flow path on a downstream side of the pump, and the process device may detect the presence or absence of leakage of the process target gas with respect to the recovery gas and an occurrence location of the leakage based on information of the oxygen concentration output from the plurality of the oxygen detectors.

A third aspect is the carbon dioxide recovery apparatus according to the first aspect described above, wherein the process device may detect a deterioration state of the adsorbent based on the information of the oxygen concentration output from the oxygen detector.

According to the first aspect described above, for example, by including a more inexpensive oxygen detector instead of a relatively expensive high-concentration carbon dioxide sensor, it is possible to prevent an increase in cost required for the apparatus configuration. It is possible to accurately detect whether or not various materials are in an easily deteriorated state by being in contact with oxygen. By arranging the relatively inexpensive oxygen detector at a plurality of locations, it is possible to easily improve the accuracy of the desired state determination.

In the case of the second aspect described above, it is possible to accurately detect the presence or absence of the leakage and the occurrence location of the leakage, and it is possible to prevent complicated time and effort in the maintenance work from being increased. For example, even if there is a leakage, it is possible to accurately determine whether or not a partial operation continuation is possible, and it is possible to prevent a decrease in an operation rate.

In the case of the third aspect described above, it is possible to accurately detect the deterioration state of the adsorbent in each reactor by the oxygen detector.

### BRIEF DESCRIPTION OF THE DRAWINGS

FIG. 1 is a configuration view of a carbon dioxide recovery apparatus according to an embodiment of the present invention.

FIG. 2 is a flowchart showing an operation of the carbon dioxide recovery apparatus according to the embodiment of the present invention.

### DESCRIPTION OF EMBODIMENTS

Hereinafter, a carbon dioxide recovery apparatus of an embodiment of the present invention will be described with reference to the accompanying drawings.

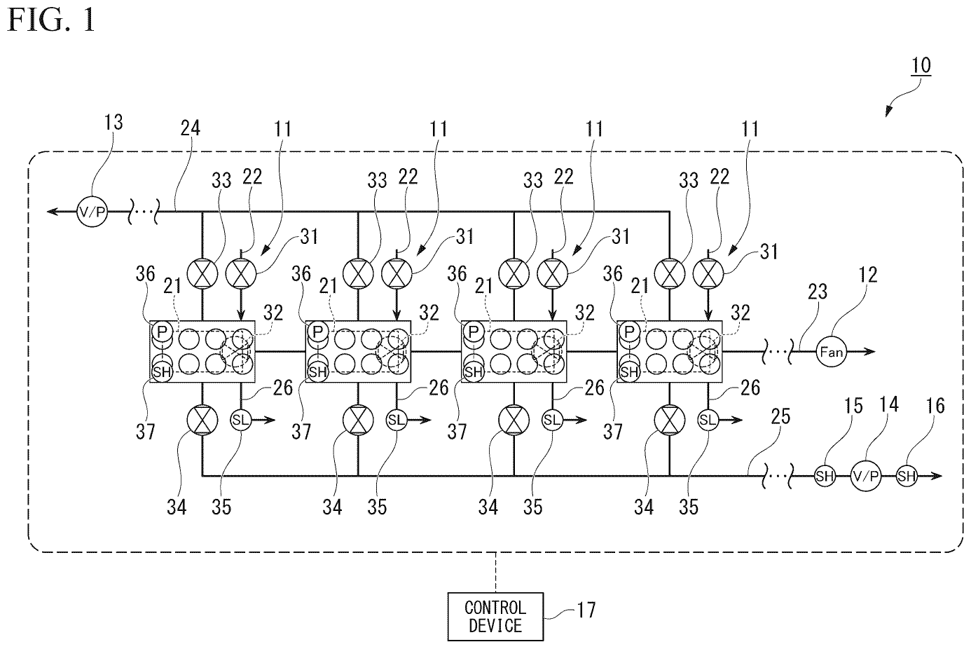

FIG. 1 is a configuration view of a carbon dioxide recovery apparatus 10 of the embodiment. The carbon dioxide recovery apparatus 10 of the embodiment is used in a so-called DAC (Direct Air Capture: a direct air recovery technique) and recovers carbon dioxide directly from the atmosphere containing diffused carbon dioxide.

As shown in FIG. 1, the carbon dioxide recovery apparatus 10 of the embodiment includes, for example, a plurality of reactors 11, an intake fan 12, a negative pressure pump 13, a recovery pump 14, a first oxygen sensor 15 (oxygen detector), a second oxygen sensor 16 (oxygen detector), and a control device 17 (process device).

Each of the plurality of reactors 11 includes, for example, a housing, a heat exchanger arranged inside the housing, and an adsorbent 21 held by the heat exchanger. The heat exchanger is, for example, a radiator or the like. The heat exchanger includes a flow path for a heat medium formed inside the heat exchanger and a plurality of fins provided on an outer surface of the heat exchanger. The heat exchanger holds the adsorbent 21 which is filled in each of a plurality of cells formed of the plurality of fins on the outer surface.

The heat exchanger of each reactor 11 is connected to, for example, an external heat pump system.

The heat exchanger heats and cools the adsorbent 21 by heat exchange between the adsorbent 21 and a heat medium circulating between the heat exchanger and the external heat pump system.

An outer shape of the adsorbent 12 is, for example, a particulate shape. The adsorbent 12 is formed of, for example, a porous material such as silica and a solid amine supported on the porous material. For example, the adsorbent 12 adsorbs carbon dioxide in a low temperature state and desorbs (emits) carbon dioxide in a high temperature state and in a low concentration state of the ambient carbon dioxide.

Each reactor 11 is connected to, for example, an air introduction flow path 22, an intake flow path 23, a negative pressure flow path 24, a recovery flow path 25, and a measurement flow path 26 via the housing. Each flow path 22, 23, 24, 25, 26 is formed of, for example, a pipe, a tube, or the like connected to the housing.

The air introduction flow path 22 includes, for example, an air introduction valve 31 that opens and cuts off the inside of each reactor 11 with respect to the external ambient atmosphere.

The intake flow path 23 is connected to, for example, the intake fan 12. The intake flow path 23 includes, for example, an intake valve 32 that opens and cuts off a space between an inside of each reactor 11 and the intake fan 12. The intake fan 12 performs an air blowing operation by suction and discharge of a gas in an open state of the intake valve 32 and thereby generates a flow of the gas by the intake and the exhaust at the inside of the reactor 11. When the carbon dioxide is actually adsorbed by the adsorbent 21, for example, in an adsorption step described later, the intake fan 12 performs the air blowing operation in an open state of each of the air introduction valve 31 and the intake valve 32. The intake fan 12 introduces air to the inside of the reactor 11 via the air introduction flow path 22 and discharges gas at the inside of the reactor 11 to the intake flow path 23.

The negative pressure flow path 24 is connected to, for example, the negative pressure pump 13. The negative pressure flow path 24 includes, for example, a negative pressure valve 33 that opens and cuts off a space between the inside of each reactor 11 and the negative pressure pump 13. The negative pressure pump 13 is, for example, a vacuum pump or the like. The negative pressure pump 13 performs an intake operation in an open state of the negative pressure valve 33 prior to a step of actually desorbing carbon dioxide from the adsorbent 21, for example, in a desorption step described later. The negative pressure pump 13 suctions the gas at the inside of the reactor 11 via the negative pressure flow path 24 and thereby causes the inside of the reactor 11 to a negative pressure state.

The recovery flow path 25 is connected to, for example, the recovery pump 14. The recovery flow path 25 includes, for example, a recovery valve 34 (open-close valve) that opens and cuts off a space between the inside of each reactor 11 and the recovery pump 14. The recovery pump 14 is, for example, a vacuum pump or the like. The recovery pump 14 performs an intake operation in an open state of the recovery valve 34 after actually desorbing carbon dioxide from the adsorbent 21, for example, in the desorption step described later. The recovery pump 14 suctions the gas at the inside of the reactor 11 via the recovery flow path 25 and thereby recovers carbon dioxide contained in the gas at the inside of the reactor 11.

The recovery flow path 25 includes, for example, a first oxygen sensor 15 that is arranged on an upstream side of the recovery pump 14 and a second oxygen sensor 16 that is arranged on a downstream side of the recovery pump 14. The first oxygen sensor 15 and the second oxygen sensor 16 detect the concentration of oxygen contained in a gas (recovery gas) recovered by the recovery pump 14.

The measurement flow path 26 includes, for example, a carbon dioxide sensor 35 that detects the carbon dioxide concentration in the gas at the inside of each reactor 11.

Each reactor 11 includes, for example, a pressure sensor 36 that detects the pressure of the gas at the inside of the reactor 11 and a third oxygen sensor 37 (oxygen detector) that detects the oxygen concentration of the gas at the inside of the reactor 11.

The control device 17 provides, for example an overall control of the operation of the carbon dioxide recovery apparatus 10. For example, the control device 17 is a software function unit that functions by a predetermined program being executed by a processor such as a CPU (Central Processing Unit). The software function unit is an ECU (Electronic Control Unit) including a processor such as a CPU, a ROM (Read Only Memory) that stores a program, a RAM (Random Access Memory) that temporarily stores data, and an electronic circuit such as a timer. At least part of the control device 17 may be an integrated circuit such as an LSI (Large Scale Integration).

Hereinafter, an operation of the carbon dioxide recovery apparatus 10 of the embodiment is described.

The control device 17 detects at least one of the carbon dioxide concentration of the recovery gas, the state of each reactor 11, and the state of the recovery flow path 25, for example, on the basis of information of the oxygen concentration output from the first oxygen sensor 15, the second oxygen sensor 16, and the third oxygen sensor 37.

For example, when a process target gas introduced to each reactor 11 is air, the control device 17 assumes that a gas other than carbon dioxide contained in the recovery gas is water vapor and air and that the water vapor of the recovery gas can be removed by cooling. The control device 17 calculates a carbon dioxide concentration C in the recovery gas on the basis of information of an oxygen concentration Ca, Cb in each of the recovery gas and the air, for example, as shown in the following mathematical expression (Expression 1).

$$C ( \% ) = 100 - ( Ca / Cb ) \times 100 \qquad ( Expression 1 )$$

For example, when the process target gas introduced to each reactor 11 is air, the control device 17 detects the presence or absence of leakage of the air with respect to the recovery gas and an occurrence location of the leakage as the state of each reactor 11 and the state of the recovery flow path 25. The control device 17 calculates a detection limit L of the leakage of the air with respect to the recovery gas on the basis of information of a resolution R of each oxygen sensor 15, 16, 37 and the oxygen concentration Cb in the air, for example, as shown in the following mathematical expression (Expression 2).

$$L ( \% ) = ( R / Cb ) \times 100 \qquad ( Expression 2 )$$

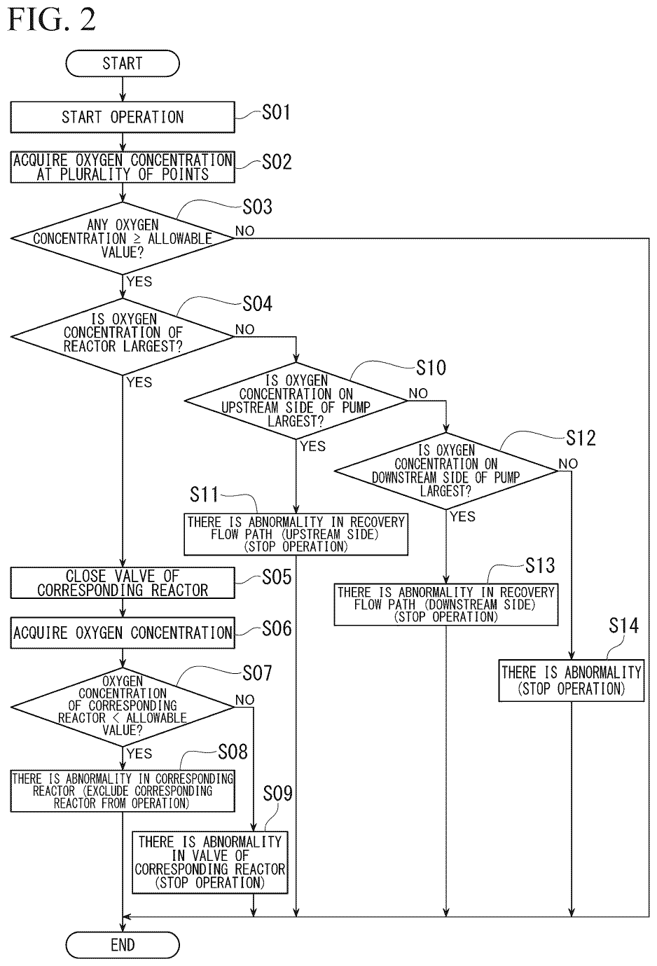

FIG. 2 is a flowchart showing an operation of the carbon dioxide recovery apparatus 10 of the embodiment. The series of processes shown in FIG. 2 are repeatedly executed at an appropriate timing such as a predetermined cycle.

As shown in FIG. 2, first, the control device 17 starts the operation of the carbon dioxide recovery apparatus 10 (Step S01).

Next, the control device 17 acquires the oxygen concentration at a plurality of predetermined locations in each reactor 11 and the recovery flow path 25 on the basis of the information of the oxygen concentration output from each oxygen sensors 15, 16, 37 (Step S02).

Next, the control device 17 determines whether or not any oxygen concentration among a plurality of acquired oxygen concentrations is equal to or more than a predetermined allowable value (Step S03). The predetermined allowable value relates to, for example, the detection limit L described above and is a lower limit value or the like at which leakage (inflow) of air with respect to the recovery gas can be detected. When the determination result is “NO”, the control device 17 advances the process to the end. On the other hand, when the determination result is “YES”, the control device 17 advances the process to Step S04.

Next, the control device 17 determines whether or not the oxygen concentration acquired from the third oxygen sensor 37 of any of the reactors 11 is the largest among the plurality of acquired oxygen concentrations (Step S04). When the determination result is “NO”, the control device 17 advances the process to Step S10.

On the other hand, when the determination result is “YES”, the control device 17 advances the process to Step S05.

Next, the control device 17 switches the recovery valve 34 of a reactor 11 corresponding to the largest oxygen concentration from an open state to a closed state (Step S05).

Next, the control device 17 newly acquires information of the oxygen concentration from the third oxygen sensor 37 of the corresponding reactor 11 (Step S06).

Next, the control device 17 determines whether or not the oxygen concentration newly acquired from the third oxygen sensor 37 of the corresponding reactor 11 is less than a predetermined allowable value (Step S07). When the determination result is “NO”, the control device 17 advances the process to Step S09. On the other hand, when the determination result is “YES”, the control device 17 advances the process to Step S08.

Next, the control device 17 determines that there is an abnormality in the corresponding reactor 11, excludes the reactor 11 from an operation target, and continues the operation by other reactors 11 (Step S08). The abnormality of the reactor 11 is, for example, the leakage of a gas in the reactor 11, deterioration of the adsorbent 21 and other materials, and the like. Then, the control device 17 advances the process to the end.

Further, the control device 17 determines that there is an abnormality in the recovery valve 34 of the corresponding reactor 11 and stops the operation of all of the reactors 11 until the replacement or repair of the recovery valve 34 is completed (Step S09). Then, the control device 17 advances the process to the end.

Further, the control device 17 determines whether or not the oxygen concentration acquired from the first oxygen sensor 15 is the largest among the plurality of acquired oxygen concentrations (Step S10). When the determination result is “NO”, the control device 17 advances the process to Step S12. On the other hand, when the determination result is “YES”, the control device 17 advances the process to Step S11.

Next, the control device 17 determines that there is an abnormality on an upstream side of the recovery pump 14 in the recovery flow path 25 and stops the operation of all of the reactors 11 until the replacement or repair of a portion on the upstream side of the recovery pump 14 in the recovery flow path 25 is completed (Step S11). Then, the control device 17 advances the process to the end.

Further, the control device 17 determines whether or not the oxygen concentration acquired from the second oxygen sensor 16 is the largest among the plurality of acquired oxygen concentrations (Step S12). When the determination result is “NO”, the control device 17 advances the process to Step S14. On the other hand, when the determination result is “YES”, the control device 17 advances the process to Step S13.

Next, the control device 17 determines that there is an abnormality on a downstream side of the recovery pump 14 in the recovery flow path 25 and stops the operation of all of the reactors 11 until the replacement or repair of a portion on the downstream side of the recovery pump 14 in the recovery flow path 25 is completed (Step S13). Then, the control device 17 advances the process to the end.

Further, the control device 17 determines that there is an abnormality in an unknown location and stops the operation of all of the reactors 11 until the abnormality is resolved (Step S14). Then, the control device 17 advances the process to the end.

As described above, according to the carbon dioxide recovery apparatus 10 of the embodiment, for example, by including a more inexpensive oxygen sensor 15, 16, 37 instead of a relatively expensive high-concentration carbon dioxide sensor, it is possible to prevent an increase in cost required for the apparatus configuration. It is possible to accurately detect whether or not various materials are in an easily deteriorated state by being in contact with oxygen on the basis of the information of the oxygen concentration acquired from each oxygen sensor 15, 16, 37. By arranging the relatively inexpensive oxygen sensor 15, 16, 37 at a plurality of locations, it is possible to easily improve the accuracy of the desired state determination.

By including the first oxygen sensor 15 and the second oxygen sensor 16 arranged on the upstream side and the downstream side of the recovery pump 14 in the recovery flow path 25, respectively, and the third oxygen sensor 37 arranged on each reactor 11, it is possible to accurately detect the presence or absence of the leakage and the occurrence location of the leakage, and it is possible to prevent complicated time and effort in the maintenance work from being increased. For example, even if there is a leakage in any of the reactors 11, it is possible to accurately determine whether or not a partial operation continuation by the other reactors 11 is possible, and it is possible to prevent a decrease in an operation rate.

It is possible to accurately detect the deterioration state of the adsorbent 21 by the third oxygen sensor 37 of each reactor 11.

The embodiments of the present invention have been presented as examples and are not intended to limit the scope of the invention. These embodiments can be implemented in a variety of other modes, and various omissions, substitutions, and changes can be made without departing from the scope of the invention. These embodiments and modifications thereof are included in the scope and gist of the invention and are also included in the scope of the invention described in the appended claims and equivalent thereof.

What is claimed is:

1. A carbon dioxide recovery apparatus comprising:
a reactor that has an adsorbent adsorbing carbon dioxide, and adsorbs and desorbs carbon dioxide in a process target gas by the adsorbent;
a recovery flow path that is connected to the reactor and causes a recovery gas recovered from the reactor to flow through the recovery flow path;
an oxygen detector that is arranged on at least one of the reactor and the recovery flow path and detects an oxygen concentration of the recovery gas; and
a process device that detects at least one of a carbon dioxide concentration of the recovery gas, a state of the reactor, and a state of the recovery flow path based on information of the oxygen concentration output from the oxygen detector.

2. The carbon dioxide recovery apparatus according to claim 1, comprising:
an open-close valve that is provided on the recovery flow path;
a pump that is provided on a downstream side of the open-close valve in the recovery flow path and suctions the recovery gas from the reactor; and
a plurality of the oxygen detectors each of which is the oxygen detector,
wherein the plurality of the oxygen detectors are provided on the reactor, in the recovery flow path between the open-close valve and the pump, and in the recovery flow path on a downstream side of the pump, and
the process device detects a presence or absence of leakage of the process target gas with respect to the recovery gas and an occurrence location of the leakage based on information of the oxygen concentration output from the plurality of the oxygen detectors.

3. The carbon dioxide recovery apparatus according to claim 1,
wherein the process device detects a deterioration state of the adsorbent based on the information of the oxygen concentration output from the oxygen detector.
